(19) United States
(12) Patent Application Publication
(10) Pub. No.: US 2022/0143435 A1
(43) Pub. Date: May 12, 2022

(54) ACTIVE FACE SHIELD AND RELATED SYSTEMS AND METHODS

(71) Applicant: MomentoMori LLC, Tel-Aviv (IL)

(72) Inventor: Benny SHOHAN, Tel-Aviv (IL)

(21) Appl. No.: 17/522,471

(22) Filed: Nov. 9, 2021

Related U.S. Application Data
(60) Provisional application No. 63/111,406, filed on Nov. 9, 2020.

(51) Int. Cl. A62B 23/02; A41D 13/11; A62B 18/08; A62B 23/06; B03C 3/32; B03C 3/12; B03C 3/66; B03C 3/41; B01D 46/00

(52) U.S. Cl. CPC A62B 23/02; A41D 13/1184; A62B 18/08; A62B 23/06; B03C 3/32; B01D 2279/40; B03C 3/66; B03C 3/41; B01D 46/0032; B03C 2201/06; B03C 3/12

(57) ABSTRACT

The present disclosure provides a face shield that includes a frame supported by a head of the wearer and a transparent visor removably coupled to the frame. When coupled to the frame, the visor extends around the face of the wearer such that the visor covers at least one of a mouth, a nose, and eyes of the wearer. The face shield further includes an ion generator coupled to the frame. The ion generator generates and emits negatively-charged ions in a region of ambient air surrounding the mouth or the nose of the wearer such that negatively-charged ions charge particulate matter suspended in the region of ambient air. The face shield includes a positively- or negatively charged or grounded trap that collects or deflects the negatively-charged ions and the particulate matter charged by the negatively-charged ions.

### CROSS-REFERENCE TO RELATED APPLICATIONS AND INCORPORATION BY REFERENCE

This application claims priority to U.S. Provisional Patent Application No. 63/111,406 filed on Nov. 9, 2020, which is incorporated by reference herein in its entirety for all purposes

### BACKGROUND

### Field of the Invention

The present disclosure relates to personal protection equipment, and in particular, to face shields having an ion generator for air purification.

### Background

Airborne matter can include various types of biological agents, such as bacteria, viruses, fungi, saliva droplets, or pathogens. Exposure to these airborne contaminants can lead to the spread of infection and disease. Airborne matter can further include a variety of air toxins and allergens, such as formaldehyde, pollen, mold spores, cigarette smoke, and pet dander. Exposure to these allergens or toxins could also lead to a malign effect on the wearer's health.

One common approach for protecting against airborne contaminants is wearing a mask. However, wearing a mask can be uncomfortable and hinder the wearer from using facial communication (e.g., showing a smile). Putting the masks on and removing can be time consuming and often difficult, particularly when other facial gear, such as glasses.

Another common approach for protecting against airborne contaminants is wearing a face shield. However, face shields cannot completely enclose the wearer's nose and mouth, thereby failing to effectively block airborne contamination from air streams passing through the gap defined between the edges of the visor and face of the wearer. Moreover, face shields are prone to fogging due to the wearer's warm, moist exhaled air typically condensing on the surfaces of the face shield. And face shields are typically cumbersome to wear for extended periods of time, not providing a fashionable look.

Thus, there is a need for an improved face shield that can effectively protect the wearer from airborne infection, obstruct physical touching of the face, and permit facial communication to others, while providing a comfortable fit and a fashionable appeal.

### BRIEF SUMMARY OF THE INVENTION

The present disclosure includes various embodiments of a face shield for obstructing particulate matter and/or biological agents from a face of a wearer.

In accordance with one embodiment, a face shield includes a frame configured to be supported by a head of the wearer. In some embodiments, a transparent visor coupled to the frame. In some embodiments, the visor configured to move between a first position and a second position. In some embodiments, at the first position, the visor extends around the face of the wearer such that the visor covers a mouth, a nose, and eyes of the wearer at a distance to permit free breathing to the wearer. In some embodiments, at the second position, a section of the visor extends away from the face of the wearer such that visor exposes at least one of the eyes, the nose, and the mouth of the wearer. In some embodiments, the face shield includes an ion generator coupled to the frame. In some embodiments, the ion generator is configured to generate and emit negatively-charged ions in a region of ambient air surrounding the mouth or the nose of the wearer such that negatively-charged ions charge particulate matter suspended in the region of ambient air.

In some embodiments, the face shield further includes a positively-charged or grounded trap configured to collect the negatively-charged ions and the particulate matter charged by the negatively-charged ions.

In some embodiments, the positively-charged trap includes a positively-charged strap coupled to the frame and extending below a chin of the wearer.

In some embodiments, the positively-charged trap includes a positively-charged surface disposed along a collection section of the visor. In some embodiments, the positively-charged trap includes a positively-charged fin projecting into the region of ambient air with the emitted negatively-charged ions.

In some embodiments, the visor comprises a photo-activated material, such as, for example, an Ag/TiO2 nanocomposite transparent coating. In some embodiments, the region of ambient air with the emitted negatively-charged ions disposed along a bottom edge of the visor.

In some embodiments, the ion generator includes a battery configured to supply current. In some embodiments, the ion generator includes an ion-emitter configured to receive current from the battery and release electrons in the region of ambient air surrounding the mouth or the nose of the wearer. In some embodiments, the ion generator includes a power converter circuit configured to increase voltage of the current supplied from the battery to the ion-emitter. In some embodiments, the ion-emitter includes an electrode, a conductive needle, or a conductive micro brush.

In some embodiments, the frame comprises a facial section extending around a face of the wearer, and the frame comprises a first temple section and a second temple section each configured to rest on an ear of the wearer.

In some embodiments, the ion emitter comprises a first ion emitter module disposed on the first temple section of the frame and a second ion emitter module disposed on the second temple section of the frame. In some embodiments, the first ion emitter module and the second ion emitter module each include a housing, a battery disposed in the housing, the battery configured to supply current, an ion-emitter configured to receive current from the battery and release electrons in the region of ambient air surrounding the mouth or the nose of the wearer, and a power converter circuit disposed in the housing, the power converter circuit configured to increase voltage of the current supplied from the battery to the ion-emitter.

In accordance with one embodiment, a face shield for obstructing particulate matter from a face of a wearer includes a frame configured to be supported by a head of a wearer. In some embodiments, the face shield includes a transparent visor removably coupled to the frame. In some embodiments, when coupled to the frame, the visor configured to extend around a face of the wearer such that the visor covers a mouth, a nose, and eyes of the wearer at a distance to permit free breathing to the wearer. In some embodiments, the face shield includes an electrostatic grill coupled to the frame. In some embodiments, the electrostatic grill includes a negatively-charged fin projecting into a region of ambient air surrounding the nose or the mouth of the wearer, and a positively-charged fin projecting into the region of ambient air surrounding the mouth or the nose of the wearer and spatially separated from the negatively charged fin. In some embodiments, the negatively-charged fin and positively charged fin are configured to capture or deflect negative ionized particulate matter or biological agents passing through the region of ambient air.

In some embodiments, the negatively-charged fin and the positively-charged fin extend below a bottom edge of the visor. In some embodiments, the negatively-charged fin and the positively-charged fin are each comprised of a silicon-based material.

In some embodiments, the visor is magnetically-coupled to the frame. In some embodiments, the visor comprises a photo-activated material, such as, for example, an Ag/TiO2 nanocomposite coating. In some embodiments, the face shield includes a positively-charged conductive surface.

In accordance with one embodiment, a face shield assembly for obstructing particulate matter from a face of a wearer includes a frame configured to be supported by a head of a wearer. In some embodiments, the face shield assembly includes a transparent visor removably coupled to the frame, the visor configured to extend around a face of the wearer such that the visor covers a mouth, a nose, and eyes of the wearer when coupled to the frame. In some embodiments, the face shield assembly includes an ion generator coupled to the frame. In some embodiments, the ion generator is configured to generate and emit negatively-charged ions in a region of ambient air surrounding the mouth or the nose of the wearer such that negatively-charged ions charge particulate matter suspended in the region of ambient air. In some embodiments, the face shield assembly includes a nasal filter configured to be received in nasal cavities of the wearer, the nasal filter comprising an electrostatic filter sheet configured to be positively or negatively charged for trapping particulate matter.

In some embodiments, the nasal filter further comprises an activated carbon filter for trapping particulate matter. In some embodiments, the face shield assembly includes a positively-charged or grounded trap configured to collect the negatively-charged ions and the particulate matter charged by the negatively-charged ions.

In accordance with one embodiment, a face shield includes a frame configured to be supported by a head of the wearer. In some embodiments, a visor coupled to the frame. In some embodiments, the visor configured to move between a first position and a second position. In some embodiments, at the first position, the visor extends around the face of the wearer such that the visor covers at least one of a mouth, a nose, and eyes of the wearer at a distance to permit free breathing to the wearer. In some embodiments, at the second position, a section of the visor extends away from the face of the wearer such that visor exposes at least one of the eyes, the nose, and the mouth of the wearer. In some embodiments, the face shield includes an ion generator coupled to the frame. In some embodiments, the ion generator is configured to generate and emit negatively-charged ions in a region of ambient air surrounding the mouth or the nose of the wearer such that negatively-charged ions charge particulate matter suspended in the region of ambient air.

In some embodiments, the frame includes a first ear section and a second ear section each configured to rest on an ear of the wearer.

In some embodiments, the ion emitter includes a first boom extending from the first ear section of the frame toward the mouth or the nose of the wearer and a second boom extending from the second ear section of the frame toward the mouth or the nose of the wearer.

In some embodiments, the ion generator includes a first battery coupled to the first ear section of the frame. In some embodiments, the ion generator includes a first ion emitter module coupled to a distal end of the first boom and configured to receive current from the first battery and release electrons in the region of ambient air surrounding the mouth or the nose of the wearer. In some embodiments, the ion generator includes a second battery coupled to the second ear section of the frame. In some embodiments, the ion generator includes a second ion emitter module coupled to a distal end of the second boom and configured to receive current from the second battery and release electrons in the region of ambient air surrounding the mouth or the nose of the wearer.

In accordance with one embodiment, a face shield for obstructing particulate matter from a face of a wearer includes a frame configured to be supported by a head of a wearer. In some embodiments, the face shield includes a visor removably coupled to the frame. In some embodiments, when coupled to the frame, the visor configured to extend around a face of the wearer such that the visor covers a mouth, a nose, and eyes of the wearer at a distance to permit free breathing to the wearer. In some embodiments, the face shield includes an ion generator coupled to the frame. In some embodiments, the ion generator is configured to generate and emit negatively-charged ions in a region of ambient air surrounding the mouth or the nose of the wearer such that negatively-charged ions charge biological agents or particulate matter suspended in the region of ambient air.

In some embodiments, the visor includes a negative electrostatic coating disposed an exterior surface of the visor and a positive electrostatic coating disposed on an interior surface of the visor.

In some embodiments, the frame includes a first ear section and a second ear section each configured to rest on an ear of the wearer, and the frame comprises a rail section. In some embodiments, the frame includes a rail section configured to extend around the back of a head of the wearer. In some embodiments, the frame includes a first fitting mechanism disposed at a first transition section between the first ear section and the rail section and a second fitting mechanism disposed at a second transition section between the second ear section and the rail section. In some embodiments, the first and second fitting mechanisms are each configured to adjust a sizing of the frame

In accordance with one embodiment, a face shield assembly for obstructing particulate matter from a face of a wearer includes a frame configured to be supported by a head of a wearer. In some embodiments, the face shield assembly includes a visor removably coupled to the frame, the visor configured to extend around a face of the wearer such that the visor covers at least one of a mouth, a nose, and eyes of the wearer when coupled to the frame. In some embodiments, the face shield assembly includes an ion generator coupled to the frame. In some embodiments, the ion generator is configured to generate and emit negatively-charged ions in a region of ambient air surrounding the mouth or the nose of the wearer such that negatively-charged ions charge particulate matter suspended in the region of ambient air. In some embodiments, the face shield assembly includes a nasal filter configured to be received in nasal cavities of the wearer, the nasal filter comprising an electrostatic filter sheet configured to be positively or negatively charged for trapping particulate matter.

In some embodiments, the region of ambient air with the emitted negatively-charged ions expands outward from about the mouth or the nose of the wearer, and a concentration of the emitted negative-charged ions within the region is greatest at an airway entering the mouth or the nose of the wearer.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a perspective view of a face shield according to some embodiments.

FIG. 2 shows a perspective view of a face shield according to some embodiments.

FIG. 3 shows a schematic view of an ion generator according to some embodiments.

FIG. 4 shows a perspective view of a face shield according to some embodiments.

FIG. 5 shows a perspective view of a face shield according to some embodiments.

FIG. 6 shows a perspective view of a face shield according to some embodiments.

FIG. 7 shows a detailed view of an electrostatic grill for a face shield according to some embodiments.

FIG. 8 shows a perspective view of a face shield according to some embodiments.

FIG. 9 shows a bottom view of a nasal filter according to some embodiments.

FIG. 10 shows a side view of a nasal filter according to some embodiments.

FIG. 11 shows a side view of a face shield according to some embodiments.

FIG. 12 shows a side view of a face shield according to some embodiments.

FIG. 13 shows a side view of a face shield according to some embodiments.

FIG. 14 shows a schematic block diagram of an exemplary computer system in which embodiments may be implemented.

FIG. 15A shows a perspective view of a face shield according to some embodiments.

FIG. 15B shows a perspective view of a face shield according to some embodiments.

FIG. 16 shows a side view of a face shield according to some embodiments.

FIG. 17 shows a side view of a face shield according to some embodiments.

FIG. 18 shows an enlarged side view of a frame of a face shield according to some embodiments.

FIG. 19 shows a side view of a visor according to some embodiments.

FIG. 20 shows an enlarged sectional view taken along line 20-20 of the visor shown in FIG. 19 according to some embodiments.

### DETAILED DESCRIPTION OF THE INVENTION

The present inventions will now be described in detail with reference to embodiments thereof as illustrated in the accompanying drawings, in which like reference numerals are used to indicate identical or functionally similar elements. References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present inventions. Other suitable modifications and adaptations of the variety of conditions and parameters normally encountered in the field, and which would be apparent to those skilled in the art, are within the spirit and scope of the inventions.

The use of facemasks and face shields has become common to filter harmful materials, such as pathogens, allergens, mold spores, dust, any other biological agent, from the inhaled and exhaled air. However, wearing such masks and shields are uncomfortable. For example, wearing a cloth mask around the mouth entraps the warm, moist air exhaled by the wearer, making the wearer feel too hot. Furthermore, wearing cloth masks around the mount and nose prevent wearers from using facial communication (e.g., smiling) with others. As another example for wearers of face shields, the wearer's warm, moist exhaled air typically condenses on the surfaces of the face shield, fogging the shield. Moreover, face shields are typically bulky, burdening the wearer and not providing a fashionable appeal to others. Face shields are typically spaced from the face of wearer, thereby not able to prevent all airborne contaminants from the entering the user's mouth and nose.

Accordingly, there is a need for a face shield that can effectively protect the wearer from airborne infection, obstruct physical touching of the face, and permit facial communication to others, while providing a comfortable fit and a fashionable appeal.

According to various embodiments described herein, the face shield of the present disclosure may overcome one or more of the deficiencies noted above by comprising a frame configured to supported by a head of the wearer, a transparent visor coupled to the frame, and an ion generator coupled to the frame. In some embodiments, the visor can extend around the face of the wearer such that the visor covers the wearer's mouth, nose, and eyes from a distance to permit free breathing to the wearing. In some embodiments, the ion generator can be configured to generate and emit negatively-charged ions in a region of ambient air surrounding the face (e.g., the mouth and/or the nose) of the wearer such that negatively-charged ions charge particulate matter suspended in the region of ambient air, ultimately purifying the air stream entering the user's mouth and nose. According to the various embodiments described herein, the face shield effectively protects the wearer against airborne contaminants disposed all around the wearer's face, unlike prior art face shields, and at the same time, the face shield does not entrap warm exhaled air, such as by wearing mask, and provides a sleek design, ultimately providing the wearer a comfortable fit and a fashionable fit.

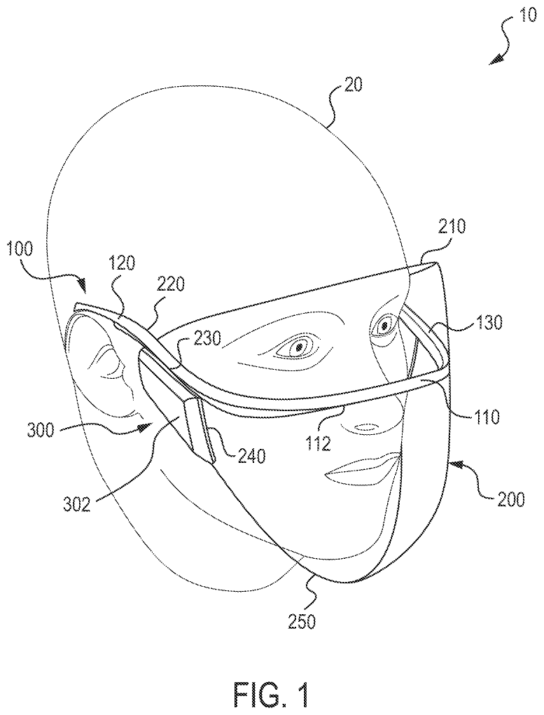

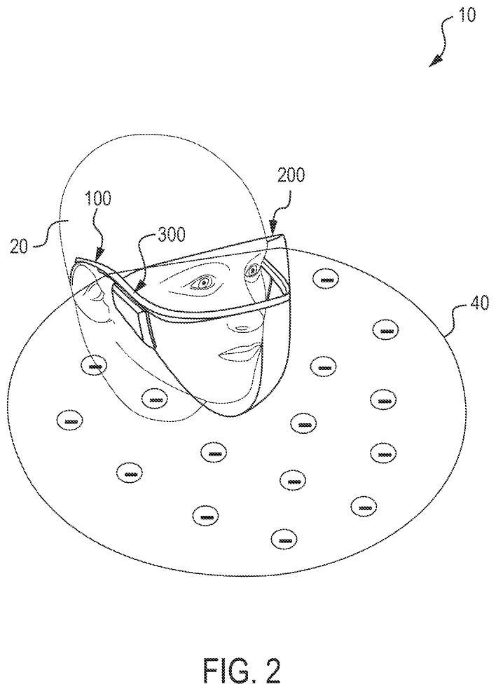

Embodiments will now be described in more detail with reference to the figures. With reference to FIGS. 1 and 2, for example, in some embodiments, a face shield 10 can include a frame 100, a visor 200 coupled to frame 100, and an ion generator 300 coupled to frame 100. In some embodiments, frame 100 can be configured to be supported by a head of a wearer 20, such as for example, resting along the ears and nose of the wearer 20. In some embodiments, visor 200 can be configured to cover the eyes, nose, and mouth of the wearer 20 at a distance such that visor 200 obstructs airborne particulate matter from entering the wearer's mouth, nose, and eyes while permitting free breathing to the wearer 20. In some embodiments, ion generator 300 can be configured to generate and discharge negatively-charged ions in a region of ambient air along the face (e.g., the mouth and/or the nose) of the wearer 20 such that negatively-charged ions confer a charge to particulate matter suspended in the region of ambient air. In some instances, the discharged ions can neutralize positively-charged particulate matter and/or biological agents. By neutralizing the positively charged particular matter and/or biological agent, ion generator 300 sterilizes the air stream entering the wearer's mouth and nose. In some instances, the discharged ions can convert the particulate matter and/or biological agent into a negative-charged particulate matter that can be collected by a positively charged surface, thereby electrostatically filtering the air stream entering the wearer's mouth and nose. Accordingly, face shield 10 can be configured to provide both a physical barrier around the wearer's face via visor 200 and a facial shield of negative ions for purifying the air stream entering the wearer's mouth and nose, thereby allowing the wearer 20 to engage in social activity (e.g., working in the office, commuting via transportation, interacting socially at restaurants and stores) with safety and visible facial interaction.

In some embodiments, frame 100 can be configured to be supported by a head of the wearer 20. In some embodiments, frame 100 can include a facial section 110 configured to extend around the face of the wearer 20. In some embodiments, frame 100 can include a first temple section 120 and a second temple section 130 each configured to extend along a temple of the wearer 20 and rest on an ear of the wearer 20. In some embodiments, frame 100 can include a nose section 112 disposed along a bottom edge of facial section 110 and configured to rest on a nose of the wearer 20.

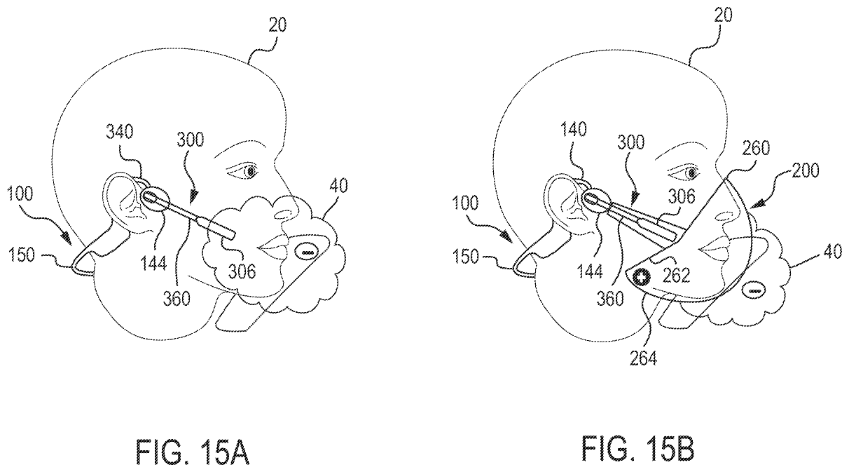

In some embodiments, as shown in FIG. 1, for example, frame 100 can include a single-piece configuration (e.g., elongated, curved bar) having sufficient elastic force to remain secured to the wearer's head when positioned properly on the wearer's head. In some embodiments, frame 100 can include a multiple piece configuration that includes a forehead piece, a pair of stems connected to the forehead piece by hinges, and a nose piece coupled to the forehead piece. In some embodiments, frame 100 can include a band circumventing the head of the wearer 20. For example, as shown in FIGS. 15A and 15B, frame 100 can include a band having a pair of ear sections 140 each configured to clip to an ear of the wearer and a rail section 150 extending from ear sections 140 and configured to wrap around the back of the wear's head and/or neck. In some embodiments, frame 100 can include the pair of ear sections 140 (e.g., an ear clip) without a rail section. In some embodiments, ear sections 140 can each include an ear bud 144 configured to be received in the opening of the wearer's ear canal or along an outer edge of the wearer's ear to secure frame 100 to wearer's head. In some embodiments, ear bud 144 can include an audio transducer (e.g., speaker) for generating sound into the wearer's ear. In some embodiments, ear bud 144 can include a battery configured to discharge current to ion generator 300.

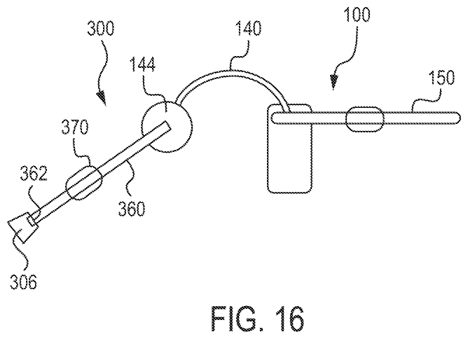

In some embodiments, as shown in FIG. 16, ear section 140 and rail section 150 of frame 100 can include a single-piece configuration, in which each ear section 140 is biased toward the opposing ear section 140. In some embodiments, frame 100 can be formed from any suitable polymeric-based material, such as a thermoplastic material, to achieve this bias. For example, frame 100 can be integrally molded from a thermoplastic material.

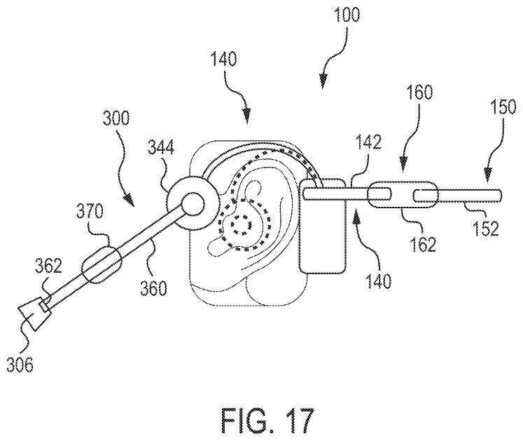

In some embodiments, frame 100 can include a fitting mechanism to adjust the sizing of frame 100 relative to the wearer's head. For example, in some embodiments, as shown in FIG. 17, the fitting mechanism of frame 100 can include a telescopic transition section 160 disposed between ear section 140 and rail section 150. In some embodiments, telescopic transition section 160 includes a tubular-shaped sleeve 162 disposed between ear section 140 and rail section 150. In some embodiments, ear section 140 includes a tube 142 movably received in sleeve 162 such that tube 142 can be displaced within sleeve 162 in an axial direction. In some embodiments, rail section 150 includes a tube 152 movably received in sleeve 162 such that tube 152 can be displaced within sleeve 162 in an axial direction. The tension of ear section 140 and/or rail section 150 can be adjusted by displacing tube 142 and/or tube 152 within sleeve 162, thereby adjusting the fit of frame 100 with respect to the wearer's head.

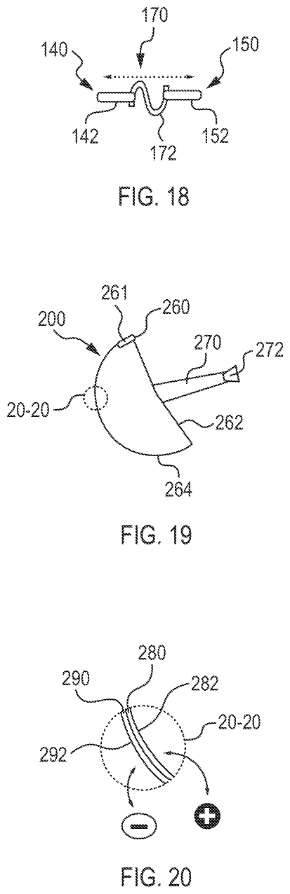

In some embodiments, as shown in FIG. 18, for example, the fitting mechanism of frame 100 can include a spring member 170 disposed between ear section 140 and rail section 150. In some embodiments, spring member 170 can include a sinusoidal-shaped tube 172 formed from a polymeric-based material possessing a suitable degree of flexibility and resiliency to deflect ear section 140 and/or rail section 150 in a circumferential direction around the wearer's head. For example, in some embodiments, sinusoidal-shaped tube 172 can be formed from a rubber-based material and/or a thermoplastic-based material. In some embodiments, ear section 140 includes a tube 142 coupled to a first end of tube 172 of spring member 170 such that tube 142 can be deflected by flexing tube 172, thereby adjusting the fit of frame 100 with respect to the wearer's head. In some embodiments, rail section 150 includes a tube 152 coupled to a second end of tube 172 of spring member 170 such that tube 152 can be deflected by flexing tube 172, thereby adjusting the fit of frame 100 with respect to the wearer's head.

In some embodiments, visor 200 can include a substrate comprised of a transparent material so that the wearer 20 can see though the visor 200. In some embodiments, visor can be comprised of a polymer material, such as, for example, polyethylene terephthalate, acrylic, polycarbonate, or a combination thereof. In some embodiments, visor can be comprised of a glass material. In some embodiment, a thickness of the visor 200 can be configured to provide sufficient rigidity to prevent collapsing, yet flexible enough to bend. In some embodiments, the thickness of the visor 30 is from about 0.01 to about 1.0 millimeters, and in such as, for example, from about 0.1 to about 0.2 millimeters.

In some embodiments, visor 200 can be shaped to cover the eyes, nose, and mouth. In some embodiments, visor can include an arcuate-shaped upper edge 210 configured to extend along a forehead of the wearer 20. In some embodiments, visor 200 can include a pair of upper lateral edges 220 each extending vertically below from an end of upper edge 210 and disposed along the temple of the wearer 20. In some embodiments, visor 200 can include a pair of stem edges 230 each extending from a respective upper lateral edge 220 and disposed along a respective temple sections 120, 130 of frame 100. In some embodiments, visor 200 can include a pair of lower lateral edges 240 extending vertically below from a respective stem edge 230. In some embodiments, visor 200 can include a parabolic-shaped bottom edge 250 extending vertically below from an end of each lower lateral edge 240 and around a chin of the wearer 20. In some embodiments, visor 200 can define a curved contour such that visor 200 bends around the face of the wearer 20. In some embodiments, the contour of visor 200 is curved along a longitudinal axis of the visor 200. In some embodiments, the contour of visor 200 is curved along a lateral axis of the visor 200.

In some embodiments, visor 200 can be shaped to cover the wearer's mouth and nose, while exposing the wearer's eyes. For example, as shown in FIGS. 15A and 15B, visor 200 can include a nose rim 260 configured to rest on the wearer's nose. In some embodiments, as shown in FIG. 19, nose rim 260 can include a nose pad 261 configured to grip the wearer's nose to promote a secured fit at the wearer's nose. In some embodiments, visor 200 can include a pair of lateral edges 262 extending from nose rim 260 toward the jaw of the wearer 20. In some embodiments, lateral edges 262 can be configured to contact a portion of the wearer's jaw to secure visor 200 to the wearer's face. In some embodiments, visor 200 can include a parabolic-shaped bottom edge 264 extending vertically below from an end of each lateral edge 262 and around a chin of the wearer 20. In some embodiments, the contour of visor 200 is curved along a longitudinal and lateral axes of the visor 200.

In some embodiments, visor 200 can be removably coupled to frame 100 such that visor 200 can be removed frame 100 when a wearer 20 no longer desires to use visor 200 (e.g., when eating). In some embodiments, visor 200 can be configured to move between a first position and a second position while coupled to frame 100. In some embodiments, when set at the first position, visor 200 extends around the face of the wearer 20 such that visor 200 covers the mouth, nose, and eyes of the wearer 20 at a distance. In some embodiments, as shown in FIGS. 15A and 15B, for example, when set at the first position, visor 200 can cover the mouth and nose of the wearer 20, while exposing the wearer's eyes. In some embodiments, when set at the second position, a section of visor 200 extends away from the face of the wearer 20 such that visor 200 exposes at least one of the eyes, nose, and mouth of the wearer 20.

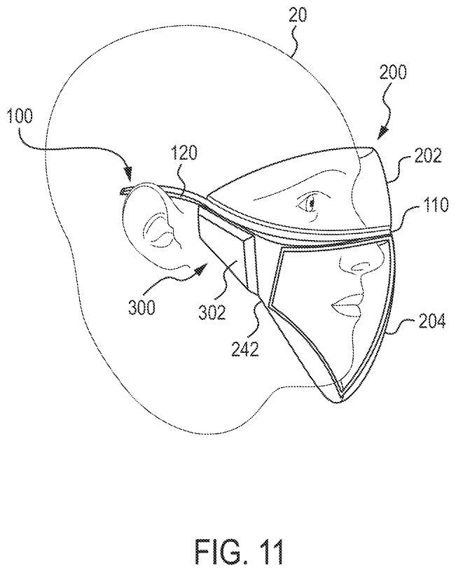

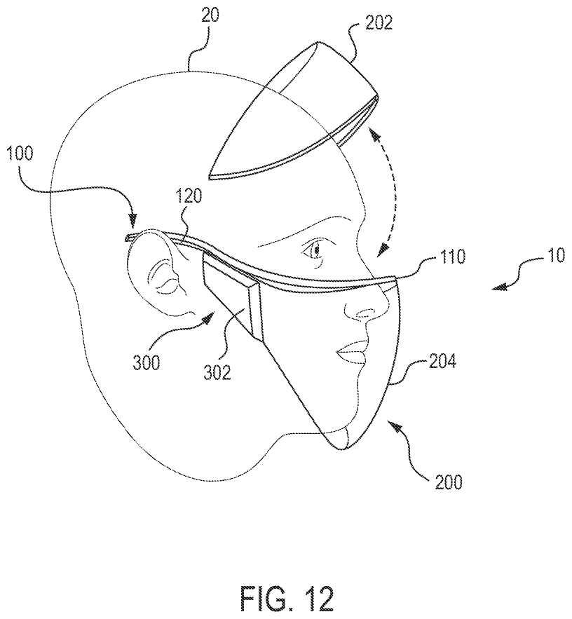

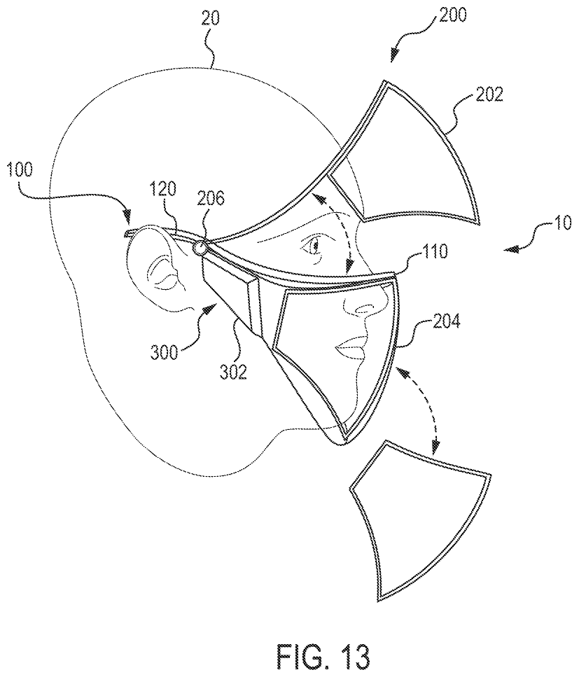

In some embodiments, visor 200 can be moved to a second position where a substantially entire portion of visor 200 is disposed away from the face of wearer 20. In some embodiments, visor 200 can include two or more sections that are each moveable to a different position to selectively expose the eyes, the nose, or the mouth of wearer 20. For example, as shown in FIG. 11, visor 200 can include an upper section 202 disposed above and removably coupled to frame 100, and visor 200 can include a lower section 204 disposed below and removably coupled to frame 100. In some embodiments, as shown in FIG. 12, for example, upper section 202 of visor 200 can be removed from frame 100 at a second position to expose the eyes of wearer 20. In some embodiments, as shown in FIG. 13, for example, lower section 204 of visor 200 can be removed from frame 100 at a third position to expose the mouth and nose of wearer 20.

In some embodiments, visor 200 can be magnetically-coupled to frame 100 by having one or more magnets disposed on frame 100 and one or more magnets disposed on visor 200. For example, in some embodiments, as shown in FIG. 19, visor 200 can include an extension 270 with a magnetic lock 272 configured to be coupled to frame 100. In some embodiments, the magnetic connection between frame 100 and visor 200 can be configured to provide a floating visor 200 such that a spatial clearance is defined between frame 100 and visor 200 while visor 200 is magnetically coupled to frame 100. In some embodiments, as shown in FIG. 13, for example, visor 200 can be pivotably coupled to frame 100, such as for example, by a hinge 206, so that visor 200 or a section of visor 200 (e.g., upper section 202) can pivot about frame 100. In some embodiments, upper section 202 of visor 200 can be pivotably coupled to frame 100 by hinge 206, and lower section 204 of visor 200 can be magnetically coupled to frame 100 such that lower section 204 can be completely removed from frame 100 when desired by wearer 20.

In some embodiments, visor 200 can include a coating composition applied to one or more surfaces or sections (e.g., partial section or entire section) of the visor 200. In some embodiments, the coating composition can be configured inhibit air exhaled by the wearer 20 from fogging visor 200. In some embodiments, the coating composition can also minimize glare from the visor 200 that would otherwise cause eye strain or fatigue for the wearer 20. In some embodiments, the coating composition can be configured to block light waves having a wavelength defined as blue light (e.g., 400-750 nanometers). In some embodiments, the coating composition can minimize reflection of different wavelengths of light, thus further enhancing the anti-glare properties. In some embodiments, the coating composition can promote accumulation of charged particles (e.g. an electrostatic trap). In some embodiments, the coating composition can include a transparent substance configured to provide anti-fog, anti-bacterial, and anti-viral properties to visor 200. In some embodiments, the coating composition applied to one or more surfaces of visor 200 can include a photo-activated material, such as, for example, a photo-activated titanium dioxide, Ag/TiO2 nanocomposite titanium transparent dioxide coating, an organic substance, or a combination thereof. In some embodiments, visor 200 can include multiple coatings applied to one or more sections of visor 200, such as for example, a first coating disposed against a section of visor 200 and a second coating applied against the first coating to provide visor 200 multiple functionalities (e.g., anti-fog and anti-bacterial).

In some embodiments, visor 200 can be formed from multiple, laminated layers of different materials with different electrostatic charges such that visor 200 is configured to deflect charged particulate matter away from the wearer's face and/or trap charged particulate matter before reaching the wearer's face. For example, as shown in FIG. 20, visor 200 can include a first shield layer 280 and a second shield layer 290 superimposed on first shield layer 280, in which the first shield layer 280 and second shield layer 290 are laminated together. In some embodiments, first shield layer 280 can have an interior surface 282 facing toward the wearer's head. In some embodiments, first shield layer 280 can have an electrostatic coating on interior surface 282 such that interior surface 282 includes a positive net charge. By having a positive net charge, interior surface 282 can collect any negatively-charged particulate matter passing through the ambient air surrounding the wearer's face. In some embodiments, second shield layer 290 can have an exterior surface 292 facing away from the wearer's head. In some embodiments, second shield layer 290 can have an electrostatic coating on exterior surface 292 such that exterior surface 292 includes a negative net charge. By having a negative net charge, exterior surface 292 can deflect any negatively-charged particulate matter away from the wearer's face. In some embodiments, the electrostatic coating can be formed from a powder material, such as a thermoplastic polymer, a thermoset polymer, an epoxy, polyester, fluoropolymer, or a combination thereof.

In some embodiments, ion generator 300 can be configured to provide a comfortable fit for the wearer 20 and comprise minimal occupancy to enhance the visual, fashionable appeal of face shield 10. In some embodiments, as shown in FIG. 1, for example, ion generator 300 can include a first ion emitter module 302 disposed on first temple section 120 of frame 100 and a second ion emitter module 304 disposed on second temple section 130 of frame 100. In some embodiments, ion generator 300 can include an array of ion emitter modules, such as, for example, three or more ion emitter modules coupled to frame 100.

In some embodiments, when positioned to cover the wearer's face, one or more edges of visor 200 can be disposed flushed against one or more sides of first and second ion emitter modules 302 and 304, thereby providing an aesthetically appealing, sleek appearance for the wearer 20. For example, in some embodiments, each stem edge 230 of visor 200 can be disposed flushed against an upper side of a respective ion emitter module 302 and 304, and each lower lateral edge 240 of visor 200 can be disposed flushed against a lateral side of a respective ion emitter module 302 and 304. In some embodiments, a lateral edge 242 of lower section 204 of visor 200 can be disposed flushed against a side of ion emitter module 302. In some embodiments, first and second ion emitter modules 302 and 304 can have substantially the same weight to provide a symmetrical weight distribution about frame 100, thereby providing a comfortable fit for the wearer 20.

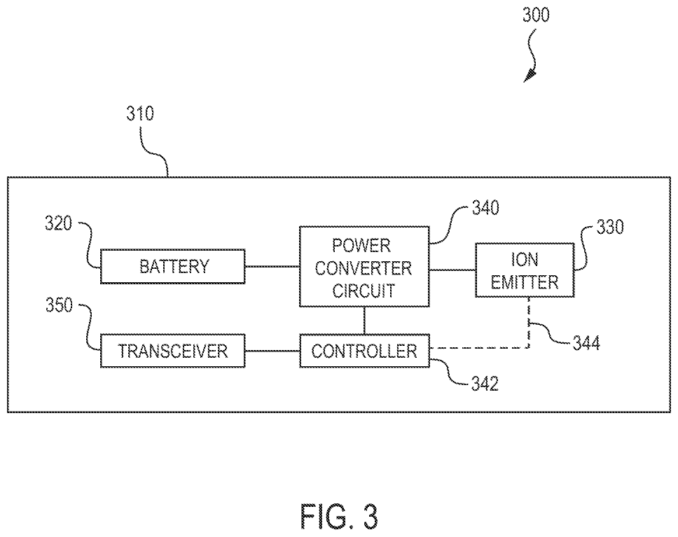

In some embodiments, as shown in FIG. 3, for example, first and second ion emitter modules 302 and 304 can each include a housing 310. In some embodiments, the first ion emitter module and the second ion emitter module can each include a power source, such as for example a battery 320, disposed in housing 310. In some embodiments, battery 320 can be configured to store a charge and supply current. In some embodiments, battery 320 is a low-voltage battery comprising a voltage capacity between about 1 volt and 10 volts, such as for example, between 3 volts and 9 volts.

In some embodiments, first and second ion emitter modules 302 and 304 each include an ion-emitter 330 configured to receive current from battery 320 and release electrons in the region of ambient air surrounding the face (e.g., the mouth and/or the nose) of the wearer 20. In some embodiments, the ion-emitter can include one or more electrodes or conductive needles. In some embodiments, the electrode can include a metal substrate. In some embodiments, the conductive needle can be comprised of a semiconductor material, such as a silicon tube.

In some embodiments, ion emitter 330 (e.g., the electrode or conductive) can include any suitable emissive surface for emitting elections upon receiving an applied voltage, such as, for example, an emissive surface comprising sharp edges, nanotubes, semiconductors with emissive properties, or a combination thereof. In some embodiments, when receiving an applied voltage, the emissive surface of ion emitter 330 (e.g., electrode or conductive needle) can be configured to emit electrons that negatively charge the surrounding air molecules and particulate matter suspended in the region of ambient air. In some embodiments, ion emitter 330 can also include any component suitable for discharging electrons in a region of ambient air surrounding the face (e.g., the mouth and/or the nose) of wearer 20, such as for example, corona discharge ionizers, ultraviolet wave generators, or plasma generators.

In some embodiments, first and second ion emitter modules 302 and 304 can each include a power converter circuit 340 disposed in the housing 310. In some embodiments, power converter circuit 340 can be configured to increase voltage (e.g., negative voltage) of the current supplied from battery 320 to ion emitter 330 so that sufficient voltage is applied to emissive surface of ion emitter 330 to release electrons into the surrounding air molecules. In some embodiments, power converter circuit 340 can regulate voltage and/or current supply to ion emitter 330 to adjust the concentration of ions generated in the region of ambient air. In some embodiments, power converter circuit 340 may include any type of circuitry component, such as for example, series resistors, current regulators (e.g., MOSFET, LDO), capacitors, diodes, amplifiers, transistors, oscillators, transformers, multipliers, and integrated circuits, suitable for regulating and transforming voltage and current supply to ion emitter 330. In some embodiments, power converter circuit 340 can include a controller 342 (e.g., a processor or application-specific-integrated circuit) having a feedback loop 344 (e.g., a sensor-circuit combination) for detecting output voltage supply to ion emitter 330 and/or concentration of ions in the region of ambient air. In some embodiments, controller 342 can limit power supply to prevent an excessively high negatively charged environment from developing, which would tend to keep particles and/or biological agents suspended, rather than allowing particles or biological agents to settle.

In some embodiments, as shown in FIG. 2, example, ion generator 300 can generate and emit negatively-charged ions in a region 40 of ambient air surrounding the face of the wearer 20, for example, the mouth and/or the nose of the wearer 20, such that the negatively-charged ions charge particulate matter and/or biological agents suspended in region 40 of ambient air. In some embodiments, region 40 of negatively-charged ions can extend across a particular section of the wearer's face, such as for example, the void space defined between bottom edge 250 of visor 200 and the chin and neck of the wearer 20, thereby purifying the air stream passing between visor 200 and the face of the wearer 20. In some embodiments, region 40 of negatively charged ions expands outward from about the mouth and/or the nose of the wearer 20, where the concentration of negatively-charged ions is denser at the airways entering the mouth and the nose of the wearer. By disposing negatively-charged ions proximate to the nose and the mouth of the wearer, ion generator 300 ensures that the air inhaled by the wearer 20 is treated by the emitted negatively-charged ions. In some embodiments, region 40 of negatively-charged ions can define a dome-shape shield covering the entire face of the wearer such that any particulate matter or biological agent streaming toward wearer's face is ionized and/or neutralized by the emitted negatively-charged ions, thereby purifying the air entering the wearer's mouth and/or nose. In some embodiments, the wearer 20 can sterilize its hands in region 40 of negatively-charged ions such that face shield 10 can provide a germicidal treatment of proximate objects located in region 40 on demand.

In some embodiments, as shown in FIGS. 15A, 15B, and 16, ion generator 300 can include a boom 360 extending from ear section 140 of frame 100 toward the mouth and/or the nose of the wearer 20. For example, boom 360 can include a proximal end coupled to ear bud 144 of frame 100 and a distal end 362 that is disposed about the cheek of the wearer 20, proximate to the mouth and/or nose of the wearer. In some embodiments, ion generator 300 can include a tip ion emitter module 306 removably coupled to distal end 362 of boom 360. For example, in some embodiments, tip ion emitter module 306 can be magnetically or mechanically coupled to distal end of boom 360. In some embodiments, tip ion emitter module 306 can include any component suitable for generating and emitting negatively-charged ions in a region 40 of ambient air surrounding the face (e.g., the mouth and/or the nose) of the wearer 20 such that the negatively-charged ions charge particulate matter and/or biological agents suspended in region 40 of ambient air. For example, in some embodiments, tip ion emitter module 306 can include any one of the components, such as housing 310, battery 320, ion emitter 330, power converter circuit 340, controller 342, feedback loop 344, and/or transceiver 350, shown in FIG. 3. In some embodiments, tip ion emitter module 306 may be configured to output negatively-charged ions in dome-shaped formation expanding outward from the mouth and/or the nose of the wearer 20. Positioning ion emitter module 306 at distal end 362 of boom 360 allows the ion generator 300 to emit a greater concentration of negatively-charged ions at the airways entering the mouth and the nose of the wearer 20, such as for example, increasing the negatively-charged ion concentration exponentially (e.g., by the power of three) in region 40 surrounding the mouth and the nose of the wearer 20. In some embodiments, a concentration of the emitted negative-charged ions in region 40 is greatest at an airway entering the mouth or the nose of the wearer 20. In some embodiments, the concentration of the emitted negatively-charged ions in region 40 decreases as moving further away from the mouth and/or nose of the wearer. For example, while an air-suspended pathogen is moving closer to toward the mouth or the nose of the wearer, the pathogen is intercepted by a greater density of negatively-charged ions in region 40, thereby increasing the likelihood of the air-suspended pathogen being sterilized before entering the nose or the mouth of the wearer 20.

In some embodiments, ion generator 300 can include a battery disposed in ear section 140 and/or rail section 150 of frame 100 and is electrically coupled to tip ion emitter module 306. In some embodiments, boom 360 can be formed from an electrically-conducting material, such as a metal or a conductive plastic. In some embodiments, boom 360 can be configured to conduct current drawn from a battery, such as a battery disposed on frame 100, and can be configured to discharge current to tip ion emitter module 306.

In some embodiments, ion generator 300 can include multiple booms 360, such as, for example, a first boom disposed on a right side of the wearer's face and a second boom disposed on a left side of the wearer's face. In some embodiments, ion generator 300 can include multiple tip ion emitter modules 306, such as, for example, a first tip ion emitter module disposed on a distal end of the first boom and a second tip ion emitter module disposed on a distal end of the second boom.

In some embodiments, ion generator 300 can include an ion sensor 370 disposed on boom 360. In some embodiments, ion sensor 370 can be configured to detect the presence of negatively or positively charged ions in the ambient air proximate to ion sensor 370. In some embodiments, ion sensor 370 can include any component suitable for detecting the presence of negatively or positively charged ions, such as, for example, a capacitor, an electrode, and/or a potentiometer.

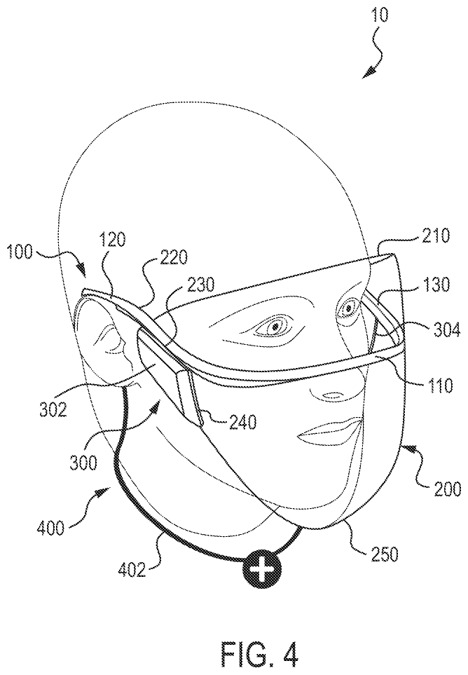

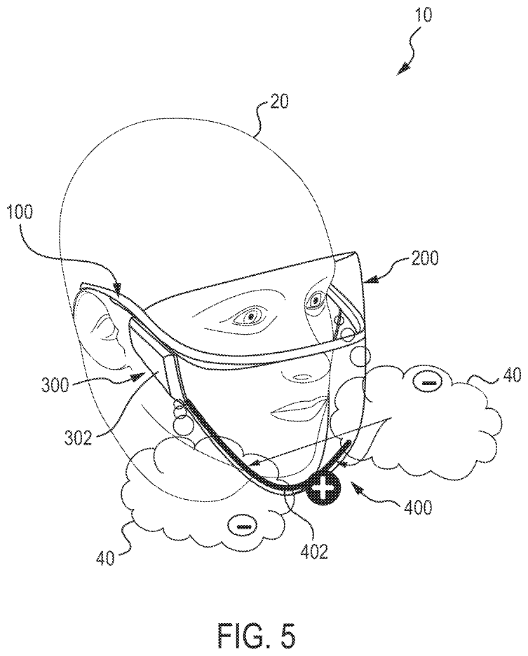

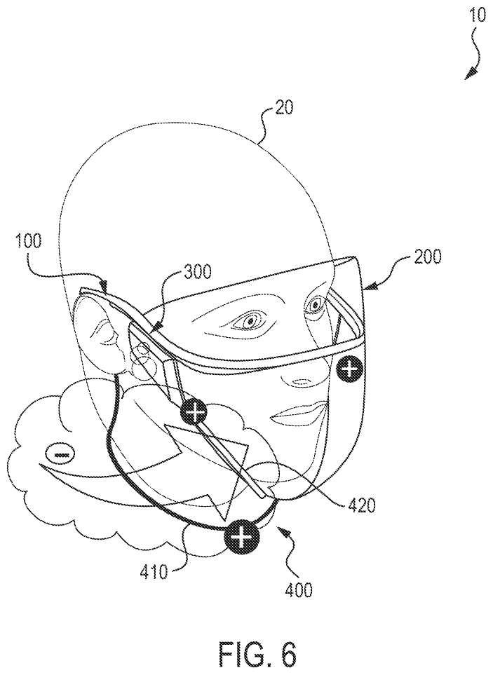

In some embodiments, as shown in FIG. 4 or 5, for example, face shield 10 can include a positively-charged or grounded trap 400 configured to collect the negatively-charged ions and the particulate matter and/or biological agents charged by the negatively-charged ions. In some embodiments, positively charged trap 400 can be electrically connected to a positive terminal of battery 320 to provide an opposite polarity with respect to negatively-charged ions. By collecting the charged particulate matter and/or biological agents, positively-charged or grounded trap 400 can promote effective removal of particulates and biological agents disposed in the air stream passing to the wearer's mouth and eyes. In some embodiments, positively-charged or grounded trap 400 is configured to prevent direct air flow from a region of ambient air surrounding wearer 20 to the mouth, nose, and/or eyes of wearer 20.

In some embodiments, positively-charged trap 400 can include a positively-charged strap 410 coupled to frame 100 and extending below a chin of the wearer 20. In some embodiments, positively-charged trap 400 can include a positively-charged surface disposed along a collection section of visor 200. In some embodiments, positively-charged trap 400 can be placed along a periphery of visor 200. For example, positively-charged trap 400 can include a positively-charged fin 420 projecting into the region of ambient air with the emitted negatively-charged ions. In some embodiments, positively-charged trap 400 can include one or more fins 420 defining a labyrinth geometry that increases the likelihood of an ionized particle meeting a charged surface.

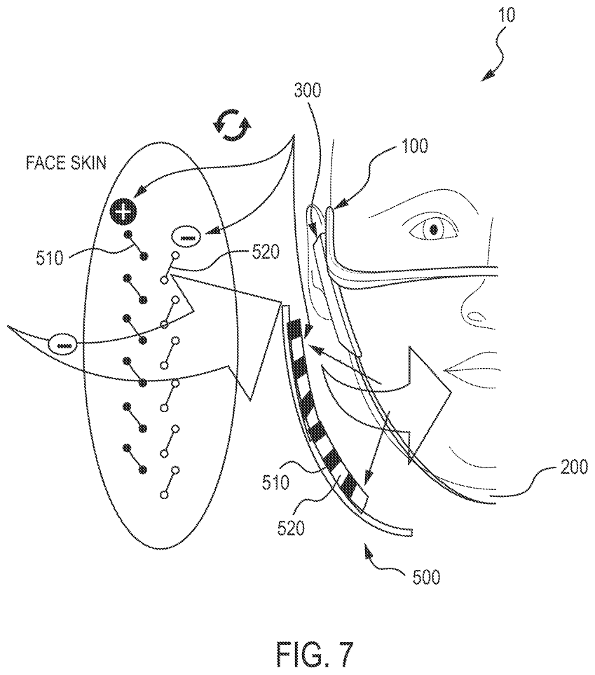

In some embodiments, as shown in FIG. 7, for example, face shield 10 can include an electrostatic grill 500 coupled to frame 100. In some embodiments, electrostatic grill includes a negatively-charged fin 510 projecting into a region of ambient air surrounding the face of the wearer 20. In some embodiments, the electrostatic grill 500 includes a positively-charged fin 520 projecting into the region of ambient air surrounding the face of the wearer 20 and spatially separated from the negatively charged fin. In some embodiments, negatively-charged fin 520 and positively charged fin 510 are configured to ionize particulate matter and/or biological agents passing through the region of ambient air and collect the ionized particulate matter and/or biological agents. In some embodiments, negatively-charged fin 520 and positively charged fin 510 are configured to deflect negative ionized particulate matter or biological agents passing through the region of ambient air surrounding the head of wearer 20.

In some embodiments, negatively-charged fin 520 and positively-charged fin 510 can extend below bottom edge 250 of visor 200. In some embodiments, negatively-charged fin 520 and positively-charged fin 510 can each be comprised of a silicon-based material. In some embodiments, negatively-charged fin 520 and positively-charged fin 510 can each be comprised of a metal-based material. In some embodiments, negatively-charged fin 520 and/or positively-charged fin 510 can be coated with an active anti-bacterial and/or anti-viral material to increase the disinfection rate of face shield 10.

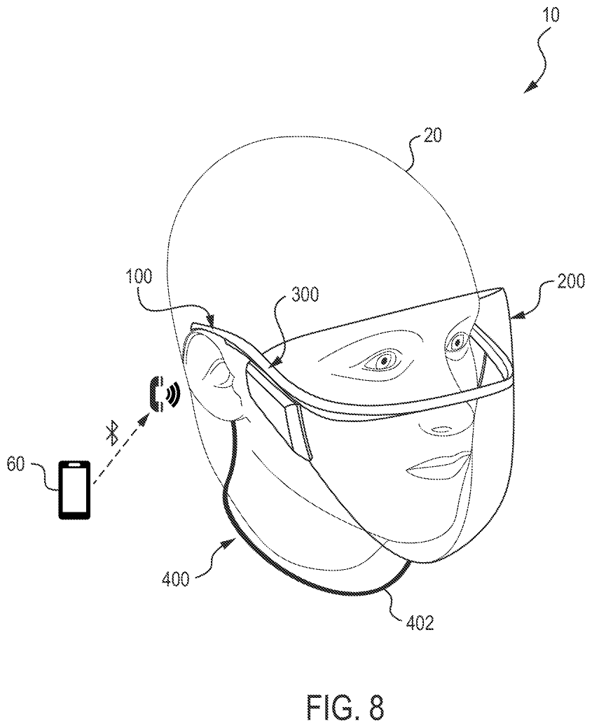

In some embodiments, as shown in FIG. 3, for example, ion generator 300 can include a transceiver 350 operatively linked to controller 342. In some embodiments, as shown in FIG. 8, for example, transceiver 350 can allow controller 342 to communicate wirelessly with a portable device 60 over a system network by a wireless communication standard defined in IEEE (e.g., NFC, Bluetooth, Local Area Network). Accordingly, in some embodiments, ion generator 300 can use transceiver 350 to exchange data or commands with a portable device 60, thereby allowing the wearer 20 to have remote control of ion generator 300 and allowing face shield 10 to indicate any operation status to wearer 20. In some embodiments, face shield 10 can include an earphone configured to communicate with portable device 60. In some embodiments, visor 200 can include a display (e.g., a LED light) configured to illuminate visor 200 to indicate an operation status of face shield 10. In some embodiments, the display can be configured to illuminate based on a signal transmitted by ion sensor 370 indicating the presence of negatively and/or positively charged ions. In some embodiments, the operation status of face shield 10 can include an active ionization mode and a passive mode in which ion generator 300 is off, and the display of visor 200 can be configured to display a different light for each operation mode. In some embodiments, face shield 10 may communicate with other face shields 10 in the system network. A system administrator may monitor data related to one or more face shields 10 in the system network.

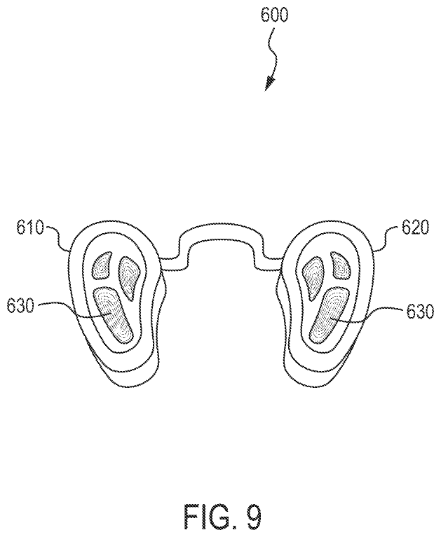

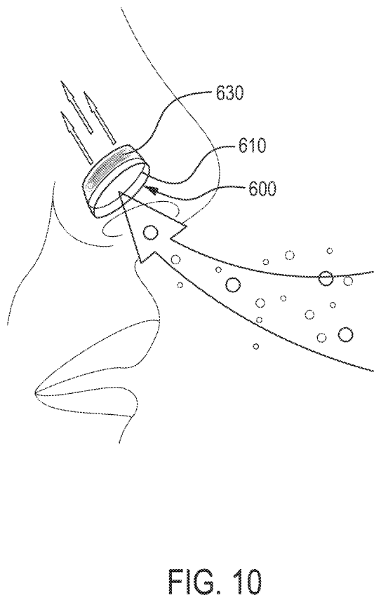

In some embodiments, as shown in FIGS. 9 and 10, the face shield may be configured as an assembly can further include a nasal filter 600 configured to be received in nasal cavities of the wearer 20. In some embodiments, nasal filter 600 can include a first nasal filter module 610 and a second nasal filter module 620 each configured to be received in a respective nasal cavity of the wearer 20. In some embodiments, nasal filter 600 can include an electrostatic filter sheet 630 for trapping particulate matter. In some embodiments, the electrostatic filter sheet 630 can include a silicon-based material configured to function as a magnet to attract to ionized particles or biological agents. In some embodiments, electrostatic filter sheet 630 can include an electrostatic gel configured to attract contaminates by gel viscosity and electrostatic charge. Accordingly, nasal filter 600 can trap any ionized particles or biological agents that pass through region of negatively-charged ions, as a second line of defense.

In some embodiments, the electrostatic filter sheet of nasal filter 600 can include woven fabric made from polyester, nylon or other polymers. In some embodiments, the woven fabric of nasal filter 600 can include intersections of the warp and weft threads to define a small apertures sized to capture particles sized between about 0.1 nanometers and 100 nanometers, such that the trapped particles are not inhaled into the respiratory system. In some embodiments, nasal filter 600 further includes an activated carbon filter for trapping particulate matter. In some embodiments, nasal filter 600 can be connected to a power source (e.g., battery 320 in ion generator 300) by a wire to be positively and/or negatively charged so that nasal filter 600 can deflect or attract the negatively-charged airborne particles entering the nose of wearer 20. In some embodiments, electrostatic filter sheet 630 can be configured to function as an isolator to maintain the charge from grounding via the skin or body of wearer 20.

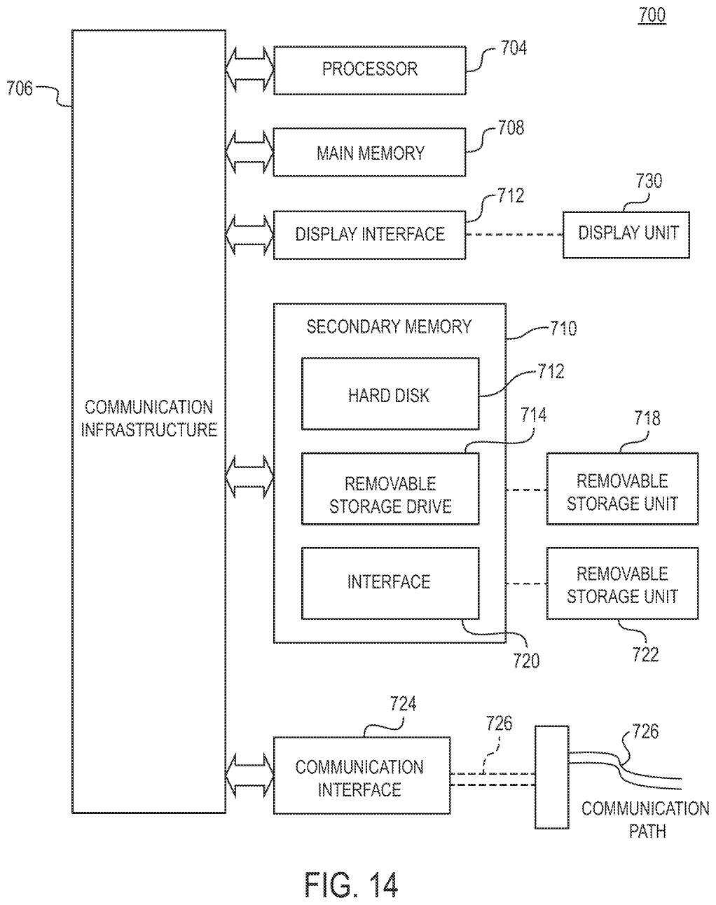

FIG. 14 illustrates an exemplary computer system 700 in which embodiments, or portions thereof, may be implemented as computer-readable code. For example, aspects of the control protocols discussed herein (e.g., any control protocol associated with controller 342) that may be implemented in one or more computer systems include, but are not limited to, controlling the power supply to the ion emitter and communication with other portable devices, may be implemented in computer system 700 using hardware, software, firmware, tangible computer readable media having instructions stored thereon, or a combination thereof and may be implemented in one or more computer systems or other processing systems.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the inventions may be implemented in terms of this example computer system 700. After reading this description, it will become apparent to a person skilled in the relevant art how to implement one or more of the inventions using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 704 may be a special purpose or a general purpose processor device. As will be appreciated by persons skilled in the relevant art, processor device 704 may also be a single processor in a multi-core/multiprocessor system, such system operating alone, or in a cluster of computing devices operating in a cluster or server farm. Processor device 704 is connected to a communication infrastructure 706, for example, a bus, message queue, network, or multi-core message-passing scheme.

Computer system 700 also includes a main memory 708, for example, random access memory (RAM), and may also include a secondary memory 710. Secondary memory 710 may include, for example, a hard disk drive 712, or removable storage drive 714. Removable storage drive 714 may include a floppy disk drive, a magnetic tape drive, an optical disk drive, a flash memory, a Universal Serial Bus (USB) drive, or the like. The removable storage drive 714 reads from and/or writes to a removable storage unit 718 in a well-known manner. Removable storage unit 718 may include a floppy disk, magnetic tape, optical disk, etc. which is read by and written to by removable storage drive 714. As will be appreciated by persons skilled in the relevant art, removable storage unit 718 includes a computer usable storage medium having stored therein computer software and/or data.

Computer system 700 (optionally) includes a display interface 702 (which can include input and output devices such as keyboards, mice, etc.) that forwards graphics, text, and other data from communication infrastructure 706 (or from a frame buffer not shown) for display on display unit 730.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communication interface 724. Communication interface 724 allows software and data to be transferred between computer system 700 and external devices. Communication interface 724 may include a modem, a network interface (such as an Ethernet card), a communication port, a PCMCIA slot and card, or the like. Software and data transferred via communication interface 724 may be in the form of signals, which may be electronic, electromagnetic, optical, or other signals capable of being received by communication interface 724. These signals may be provided to communication interface 724 via a communication path 726. Communication path 726 carries signals and may be implemented using wire or cable, fiber optics, a phone line, a cellular phone link, an RF link or other communication channels.

In this document, the terms “computer program medium” and “computer usable medium” are used to generally refer to media such as removable storage unit 718, removable storage unit 722, and a hard disk installed in hard disk drive 712. Computer program medium and computer usable medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communication interface 724. Such computer programs, when executed, enable computer system 700 to implement the embodiments as discussed herein. In particular, the computer programs, when executed, enable processor device 704 to implement the processes of the embodiments discussed here. Accordingly, such computer programs represent controllers of the computer system 700. Where the embodiments are implemented using software, the software may be stored in a computer program product and loaded into computer system 700 using removable storage drive 714, interface 720, and hard disk drive 712, or communication interface 724.

Embodiments of the inventions also may be directed to computer program products comprising software stored on any computer useable medium. Such software, when executed in one or more data processing device, causes a data processing device(s) to operate as described herein. Embodiments of the inventions may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The foregoing description of the specific embodiments will so fully reveal the general nature of the invention(s) that others can, by applying knowledge within the skill of the art, readily modify and/or adapt for various applications such specific embodiments, without undue experimentation, without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A face shield for obstructing particulate matter from a face of a wearer, comprising:
a frame configured to be supported by a head of the wearer;
a visor coupled to the frame, the visor configured to move between a first position and a second position, wherein at the first position, the visor extends around the face of the wearer such that the visor covers at least one of a mouth, a nose, and eyes of the wearer at a distance to permit free breathing to the wearer, and wherein at the second position, a section of the visor extends away from the face of the wearer such that visor exposes at least one of the eyes, the nose, and the mouth of the wearer; and
an ion generator coupled to the frame, the ion generator configured to generate and emit negatively-charged ions in a region of ambient air surrounding the mouth or the nose of the wearer such that negatively-charged ions charge biological agents or particulate matter suspended in the region of ambient air.

2. The face shield of claim 1 further comprising:
a positively-charged or grounded trap configured to collect the negatively-charged ions and the charged biological agents or particulate matter.

3. The face shield of claim 2, wherein the positively-charged trap includes a positively-charged strap coupled to the frame and extending below a chin of the wearer.

4. The face shield of claim 2, wherein the positively-charged trap includes a positively-charged surface disposed along a collection section of the visor.

5. The face shield of claim 2, wherein the positively-charged trap includes a positively-charged fin projecting into the region of ambient air with the emitted negatively-charged ions.

6. The face shield of claim 1, wherein the visor comprises a photo-activated material.

7. The face shield of claim 1, wherein the ion generator includes:
a battery configured to supply current,
an ion-emitter configured to receive current from the battery and release electrons in the region of ambient air surrounding the mouth or the nose of the wearer, and
a power converter circuit configured to increase voltage of the current supplied from the battery to the ion-emitter.

8. The face shield of claim 7, wherein the ion-emitter includes an electrode, a conductive needle, or a conductive micro brush.

9. The face shield of claim 1, wherein the frame comprises a first ear section and a second ear section each configured to rest on an ear of the wearer.

10. The face shield of claim 9, wherein the ion emitter comprises a first boom extending from the first ear section of the frame toward the mouth or the nose of the wearer and a second boom extending from the second ear section of the frame toward the mouth or the nose of the wearer.

11. The face shield of claim 10, wherein the ion generator comprises:
a first battery coupled to the first ear section of the frame,
a first ion emitter module coupled to a distal end of the first boom and configured to receive current from the first battery and release electrons in the region of ambient air surrounding the mouth or the nose of the wearer,
a second battery coupled to the second ear section of the frame,
a second ion emitter module coupled to a distal end of the second boom and configured to receive current from the second battery and release electrons in the region of ambient air surrounding the mouth or the nose of the wearer.

12. The face shield of claim 1, wherein the region of ambient air with the emitted negatively-charged ions expands outward from about the mouth or the nose of the wearer, and a concentration of the emitted negative-charged ions within the region is greatest at an airway entering the mouth or the nose of the wearer.

13. A face shield for obstructing particulate matter from a face of a wearer, comprising:
a frame configured to be supported by a head of a wearer;
a visor removably coupled to the frame, when coupled to the frame, the visor is configured to extend around a face of the wearer such that the visor covers at least one of a mouth, a nose, and eyes of the wearer at a distance to permit free breathing to the wearer; and
an ion generator coupled to the frame, the ion generator configured to generate and emit negatively-charged ions in a region of ambient air surrounding the mouth or the nose of the wearer such that negatively-charged ions charge biological agents or particulate matter suspended in the region of ambient air.

14. The face shield of claim 13, wherein the visor comprises a negative electrostatic coating disposed on an exterior surface of the visor and a positive electrostatic coating disposed on an interior surface of the visor.

15. The face shield of claim 13, wherein the frame comprises:
a first ear section and a second ear section each configured to rest on an ear of the wearer, and the frame comprises a rail section,
a rail section configured to extend around the back of a head of the wearer,
a first fitting mechanism disposed at a first transition section between the first ear section and the rail section and a second fitting mechanism disposed at a second transition section between the second ear section and the rail section, wherein the first and second fitting mechanisms are each configured to adjust a sizing of the frame.

16. The face shield of claim 13, wherein the visor is magnetically-coupled to the frame.

17. The face shield of claim 13, wherein the visor comprises a photo-activated material.

18. A face shield assembly for obstructing particulate matter from a face of a wearer, comprising:
a frame configured to be supported by a head of a wearer;
a visor removably coupled to the frame, the visor configured to extend around a face of the wearer such that the visor covers at least one of a mouth, a nose, and eyes of the wearer at a distance to permit free breathing to the wearer;
an ion generator coupled to the frame, the ion generator configured to generate and emit negatively-charged ions in a region of ambient air surrounding the mouth or the nose of the wearer such that negatively-charged ions charge particulate matter or biological agents suspended in the region of ambient air; and
a nasal filter configured to be received in nasal cavities of the wearer, the nasal filter comprising an electrostatic filter sheet configured to be positively or negatively charged for trapping or deflecting particulate matter or biological agents.

19. The facial shield assembly of claim 18, wherein the nasal filter further comprises an activated carbon filter for trapping particulate matter or biological agents.

20. The face shield assembly of claim 18 further comprising:
a positively-charged or grounded trap configured to collect the negatively-charged ions and the charged particulate matter or biological agents.
